(19) United States
(12) Patent Application Publication
(10) Pub. No.: US 2015/0288648 A1
(43) Pub. Date: Oct. 8, 2015

(54) METHOD AND APPARATUS FOR MANAGING DNS ADDRESSES

(71) Applicant: Samsung Electronics Co., Ltd., Gyeonggi-do (KR)

(72) Inventors: Jeongseok Seo, Gyeonggi-do (KR); Dongwook Lee, Gyeonggi-do (KR)

(21) Appl. No.: 14/680,907

(22) Filed: Apr. 7, 2015

(30) Foreign Application Priority Data
Apr. 7, 2014 (KR) 10-2014-0041025

(51) Int. Cl. H04L 29/12

(52) U.S. Cl. CPC H04L 61/1511; H04L 61/6009

(57) ABSTRACT

Provided are a method and apparatus to manage Domain Name System (DNS) addresses in an electronic device. The method includes monitoring the path of a network. The method also includes converting, upon detecting a change in the network path to a new network, DNS addresses stored in a DNS cache to conform to the new network. The method also includes updating the DNS cache with the converted DNS addresses. It is possible to make various modifications to the above method.

### CROSS-REFERENCE TO RELATED APPLICATION(S) AND CLAIM OF PRIORITY

The present application is related to and claims the benefit under 35 U.S.C. §119(a) of a Korean patent application filed on Apr. 7, 2014 in the Korean Intellectual Property Office and assigned Serial No. 10-2014-0041025, the entire disclosure of which is hereby incorporated by reference.

### TECHNICAL FIELD

The present application relates to a method and apparatus for managing DNS addresses in an electronic device.

### BACKGROUND

Recent advances in digital technologies have enabled popularization of various electronic devices supporting communication and personal information processing, such as mobile communication terminals, smartphones, and tablet computers. Such an electronic device provides various services and functions including a voice call service, video call service, short message service (SMS), multimedia message service (MMS), electronic mail, image capture, playback of images or media (video or music), Internet access, instant messaging, and social networking service (SNS). For an application running on an electronic device to connect to a network for data transmission and reception, to the electronic device obtains an IP address corresponding to a desired domain name using a Domain Name System (DNS) query.

### SUMMARY

When the network path or bearer is changed (such as from a cellular network to a Wi-Fi network, or from a Wi-Fi network to a cellular network), as contents of the existing DNS cache may be invalidated, the electronic device may have to obtain DNS addresses according to the changed network and thus experience delayed network responses.

To address the above-discussed deficiencies, it is a primary object to provide a method and apparatus that, when the network path is changed, enable an electronic device to update the existing DNS cache with addresses corresponding to the new network so as to enhance network performance.

In a first example, a method to manage Domain Name System (DNS) addresses in an electronic device is provided. The method includes monitoring a path of a network. The method also includes converting, upon detecting a change in the network path, DNS addresses stored in a DNS cache to conform the DNS address to the new network. The method further includes updating the DNS cache with the converted DNS addresses.

In a second example, an electronic device configured to manage Domain Name System (DNS) address is provided. The electronic device includes a communication unit configured to monitor a network path and sense a change in the network path through monitoring. The electronic device also includes a control unit configured to control, upon detecting the change in the network path, a process to convert DNS addresses stored in a DNS cache to conform with to the new network. The control unit is also configured to update the DNS cache with the converted DNS addresses.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example network environment including an electronic device according to this disclosure;

FIG. 2 is a block diagram of an example electronic device according to this disclosure;

FIG. 3 is a flowchart of an example procedure to update DNS cache according to this disclosure;

FIG. 4 is a flowchart of an example procedure to conform a DNS address with network path change according to this disclosure; and

FIG. 5 is a block diagram of an example electronic device according to this disclosure.

### DETAILED DESCRIPTION

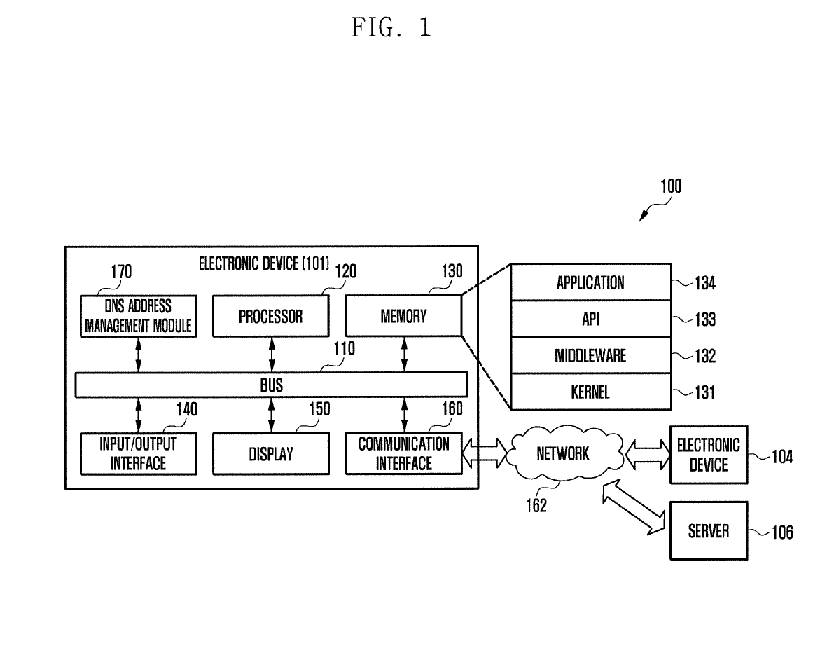

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic device and communication system. Exemplary embodiments of the present disclosure are described with reference to the accompanying drawings in detail. Various changes may be made to the disclosure, and the disclosure may have various forms, such that exemplary embodiments will be illustrated in the drawings and described in detail. However, such an embodiment is not intended to limit the disclosure to the disclosed exemplary embodiment and it should be understood that the embodiment include all changes, equivalents, and substitutes within the spirit and scope of the disclosure. Throughout the drawings, like reference numerals refer to like components.

It will be understood that the expressions “comprises” and “may comprise” is used to specify presence of disclosed function, operation, component, etc. but do not preclude the presence of one or more functions, operations, components, etc. It will be further understood that the terms “comprises” and/or “has” when used in this specification, specify the presence of stated feature, number, step, operation, component, element, or a combination thereof but do not preclude the presence or addition of one or more other features, numbers, steps, operations, components, elements, or combinations thereof. In the present disclosure, the expression “and/or” is taken as specific disclosure of each and any combination of enumerated things. For example, A and/or B is to be taken as specific disclosure of each of A, B, and A and B.

As used herein, terms such as “first,” “second,” etc. are used to describe various components, however, it is obvious that the components should not be defined by these terms. For example, the terms do not restrict the order and/or importance of the corresponding components. The terms are used only for distinguishing one component from another component. For example, a first component may be referred to as a second component and likewise, a second component may also be referred to as a first component, without departing from the teaching of the inventive concept.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise.

Unless otherwise defined herein, all terms including technical or scientific terms used herein have the same meanings as commonly understood by those skilled in the art to which the present disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

According to various embodiments of the present disclosure, the electronic device includes devices having an operation support function. Examples of the electronic device include smartphone, table Personal Computer (PC), mobile phone, video phone, electronic book (e-book) reader, desktop PC, laptop PC, netbook computer, Personal Digital Assistant (PDA), Portable Multimedia Player (PMP), MP3 player, mobile medical appliance, camera, wearable device (such as a head-mounted device (HMD) such as electronic glasses, electronic clothing, electronic bracelet, electronic necklace, electronic appcessory, electronic tattoo, smartwatch, or the like.

According to an embodiment, the electronic device is a smart home appliances having operation support function. Examples of the smart electronic appliance as an electronic device include television, Digital Video Disk (DVD) player, audio player, refrigerator, air-conditioner, vacuum cleaner, electronic oven, microwave oven, laundry machine, air cleaner, set-to box, TV box (such as a SAMSUNG HOMESYNC™, APPLE TV™, and GOOGLE TV™), game console, electronic dictionary, electronic key, camcorder, and electronic frame, or the like.

According to an embodiment, examples of the electronic device include medical devices (such as a Magnetic Resonance Angiography (MRA), a Magnetic Resonance Imaging (MRI), and a Computed Tomography (CT)), Navigation devices, Global Positioning System (GPS) receivers, Event Data Recorders (EDR), Flight Data Recorders (FDR), car infotainment devices, maritime electronic devices (such as a maritime navigation device and a gyro compass), aviation electronic devices (avionics), security devices, vehicle head units, industrial or home robots, Automatic Teller's Machines (ATM) of a financial institution, Point Of Sales (POS), or the like.

According to an embodiment, examples of the electronic device include furniture and building/structure having a communication function, electronic board, electronic signature receiving device, projector, and metering device (such as water, electric, gas, and electric wave metering devices). According to various embodiments, the electronic device is any combination of the aforementioned devices. According to various embodiments of the present disclosure, the electronic device is a flexible device. It is obvious to those skilled in the art that the electronic device is not limited to the aforementioned devices.

Descriptions are made of the electronic devices according to various embodiments with reference to accompanying drawings hereinafter. The term ‘user’ used in various embodiments denotes a person or a device (such as an artificial intelligent electronic device) using the electronic device.

In various embodiments of the present disclosure, network path monitoring refers to activities performed to check whether the path of the network is changed during data transmission and reception. Here, the network is an Ethernet network, cellular network, Wi-Fi network, Wi-Fi Direct network, BLUETOOTH network, or USB tethered network. Occurrence of a network path change (such as from a cellular network to a Wi-Fi network, or from a Wi-Fi network to a cellular network) is detected through network path monitoring.

Recent advances in digital technologies have enabled popularization of various electronic devices supporting communication and personal information processing, such as mobile communication terminals, smartphones, and tablet computers. Such an electronic device provides various services and functions including a voice call service, video call service, short message service (SMS), multimedia message service (MMS), electronic mail, image capture, playback of images or media (video or music), Internet access, instant messaging, and social networking service (SNS). For an application running on an electronic device to connect to a network for data transmission and reception, to the electronic device obtains an IP address corresponding to a desired domain name. To this end, the electronic device sends a Domain Name System (DNS) query to the DNS server and obtains an IP address corresponding to a desired domain name. The electronic device stores frequently used domain names and corresponding IP addresses in the DNS cache. Later, when a DNS query is issued, the electronic device looks up the DNS cache for a desired domain name. If a match is found, the electronic device returns the corresponding IP address.

In one embodiment, DNS addresses frequently used through the network are stored in the DNS cache in order of priority. High priorities are assigned to recently used DNS addresses (for example, the Least Recently Used (LRU) policy—the least recently used DNS address is discarded from the DNS cache) or to frequently used DNS addresses.

In one embodiment, the electronic device stores DNS addresses frequently used through the network in the DNS cache, assign high priorities to recently used DNS addresses, and update the DNS cache on the basis of priority. When a change in the network path (bearer) is detected through network path monitoring, the electronic device converts DNS addresses associated with the old network into DNS addresses associated with the new network and update the DNS cache with the DNS addresses associated with the new network. Accordingly, when a change occurs in the network path, the DNS cache is updated in accordance with the new network path, heightening network response speed.

FIG. 1 illustrates an example network environment 100 including an electronic device 101 according to this disclosure. The electronic device 101 includes a bus 110, a processor 120, a memory 130, an input/output interface 140, a display 150, a communication interface 160, and a DNS address management module 170. The bus 110 connects the aforementioned components to each other and is a circuit to exchange signals (such as control messages) among the components.

For example, the processor 120 receives a command from any of the aforementioned components (such as memory 130, input/output interface 140, display 150, communication interface 160, and DNS address management module 170) through the bus 110, interprets the command, and executes operation or data processing according to the decrypted command. The memory 130 stores the command or data received from the processor 120 or other components (such as input/output interface 140, display 150, communication interface 160, DNS address management module 170, or the like) or generated by the processor 120 or other components. The memory 130 stores program modules including kernel 131, middleware 132, Application Programming Interface (API) 133, applications 134, or the like. Each programming module is implemented as software, firmware, hardware, and any combination thereof.

The kernel 131 controls or manages the system resources (such as bus 110, processor 120, and memory 130) for use in executing the operation or function implemented with the middleware 132, the API 133, or the application 134. The kernel 131 also provides an interface allowing the middleware 132, API 133, or application 134 to access the components of the electronic device 101 to control or manage. The middleware 132 works as a relay of data communicated between the API 133 or application 134 and the kernel 131. The middle 132 executes control of the task requests from the applications 134 in such a way of assigning priority for use of the system resource (such as bus 110, processor 120, and memory 130) of the electronic device to at least one of the applications 134.

The API 133 is the interface for the applications 134 to control the function provided by the kernel 131 or the middleware 132 and includes at least one interface or function (such as command) for file control, window control, image control, or text control. According to various embodiments, the applications 134 includes Short Messaging Service/Multimedia Messaging Service (SMS/MMS) application, email application, calendar application, alarm application, health care application (such as an application of measuring quantity of motion or blood sugar level), and environmental information application (such as atmospheric pressure, humidity, and temperature applications). Additionally or alternatively, the application 134 is an application related to information exchange between the electronic device 101 and other external electronic device (such as electronic device 104). Examples of the information exchange application include a notification relay application for relaying specific information to the external electronic device and a device management application for managing the external electronic device.

For example, the notification relay application is provided with a function of relaying the alarm information generated by the other applications (such as an SMS/MMS application, email application, health care application, and environmental information application) of the electronic device 101 to an external electronic device (such as electronic device 104). Additionally or alternatively, the notification relay application provides the user with the notification information received from an external electronic device (such as electronic device 104). The electronic device application manages (such as install, delete, and update) the function of an external electronic device (such as turn-on/off of the electronic device 104 itself (or a part of it) or adjustment of the brightness (or resolution) of the display) that communicates with the electronic device 101 or the service (such as a communication or messaging service) provided by the external electronic device or an application running on the external device.

According to various embodiments, the application 134 includes an application designated according to the property (such as a type) of an external electronic device (electronic device 104). If the external electronic device is the MP3 player, the application 134 includes a music playback application. Similarly, if the external electronic device is a mobile medical appliance, the application 134 includes a heal care application. According to an embodiment, the application 134 includes at least one of applications designated to the electronic device 101 or the applications received from the external electronic device (such as server 106 and electronic device 104).

The input/output interface 140 delivers the command or data input by the user through with an input/output device (such as a sensor, keyboard, and touchscreen) to the processor 120, memory 130, communication interface 160, and/or DNS address management module 170 through the bus 110. For example, the input/output interface 140 provides the processor 120 with the data corresponding to the touch by the user on the touchscreen. The input/output interface 140 outputs the command or data (which is received from the processor 120, memory 130, communication interfaced 160, or the DNS address management module 170 through the bus 110) through the input/output device (such as a speaker and a display). For example, the input/out interface 140 outputs the voice data processed by the processor 120 to the user through the speaker. The display 150 presents various information (such as multimedia data and text data) to the user.

The communication interface 160 establishes a communication connection of the electronic device 101 with an external device (such as electronic device 104 and server 106). For example, the communication interface 160 connects to the network 162 through a wireless or wired link for communication with the external device. Examples of the wireless communication technology includes wireless fidelity (Wi-Fi), BLUETOOTH (BT), Near Field Communication (NFC), Global Positioning System (GPS), and cellular communication technology (such as Long Term Evolution (LTE), LTE-Advanced (LTE-A), Code Division Multiple Access (CDMA), Wideband CDMA (WCDMA), Universal Mobile Telecommunication System (UMTS), Wireless-Broadband (WiBro), and General System for Mobile communications (GSM)). Examples of the wired communication technology include Universal Serial Bus (USB), High Definition Multimedia Interface (HDMI), Recommended Standard 232 (RS-232), and Plain Old Telephone Service (POTS).

According to an embodiment, the network 162 is a telecommunication network. The communication network includes at least one of computer network, Internet, Internet of Things, and telephone network. According to an embodiment, the communication protocol between the electronic device 101 and an external device (such as a transport layer protocol, a data link layer protocol, and a physical layer protocol) is supported by at least one of the applications 134, API 133, middleware 132, kernel 131, and communication interface 160. In one embodiment, at least a portion of the function of the electronic device 101 (such as DNS address management module 170) is executed by an external device (such as server 106). For example, the server 106 includes a DNS address management server module corresponding to the DNS address management module 170, process at least a portion of the DNS address management function by use of the DNS address management server module, and forward the processed result to the electronic device 101 (such as DNS address management module 170).

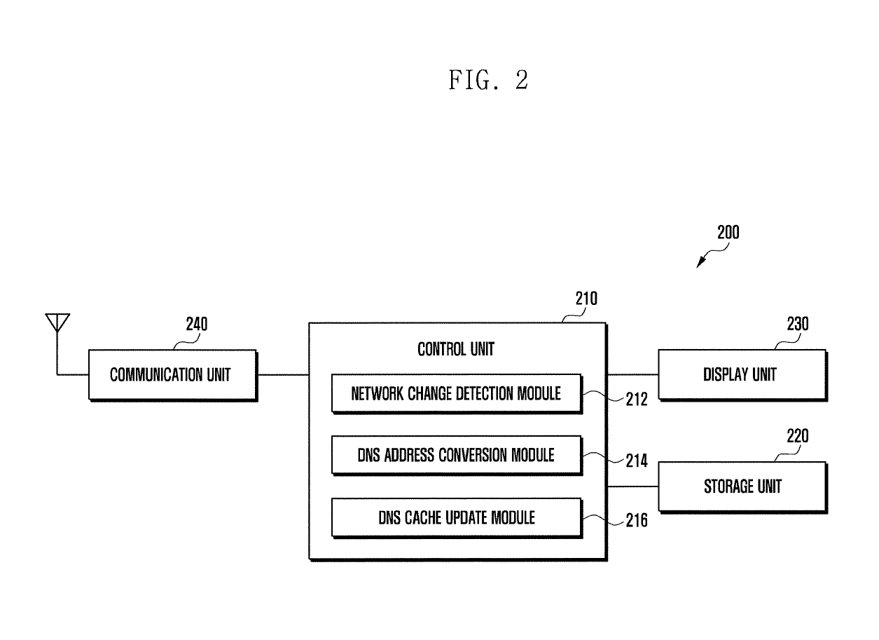

FIG. 2 is a block diagram of an example electronic device 200 supporting address management (such as electronic device 101) according to this disclosure. The electronic device 200 includes a control unit 210, a storage unit 220, a display unit 230, and a communication unit 240. In FIG. 2, the control unit 210 is a processor (such as an application processor), hardware module, or software module, or a combination thereof. For example, the control unit 210 includes a control logic corresponding to at least a portion of the function of the DNS address management module 170 executed by the processor 120. To manage addresses, the DNS address management module 170 of the control unit 210 includes a network change detection module 212, a DNS address conversion module 214, and a DNS cache update module 216.

When a network path change is detected through the communication unit 240, the control unit 210 loads DNS addresses from the DNS cache, convert the stored DNS addresses into DNS addresses conforming to the new network, and update the DNS cache with the converted DNS addresses. For network performance, the control unit 210 monitors network traffic and adjust the speed or timing of DNS cache update when network traffic is high. For example, the control unit 210 converts some of DNS addresses in the DNS cache first into DNS addresses conforming to the new network. When network traffic is high, the control unit 210 converts some of DNS addresses stored in the DNS cache first; and when network traffic is low, the control unit 210 converts all the DNS addresses stored in the DNS cache into DNS addresses conforming to the new network in a lump. The control unit 210 updates the DNS cache with DNS addresses converted in stages or in a lump for continued communication.

In the control unit 210, the network change detection module 212 detects occurrence of a network change through network monitoring. When a network change is detected by the network change detection module 212, the DNS address conversion module 214 performs DNS address conversion in accordance with the new network. The DNS cache update module 216 updates the DNS cache with DNS addresses output by the DNS address conversion module 214. The storage unit 220 (such as memory 130) stores frequently accessed DNS addresses in order of priority based on a recent use or frequency of use. The display unit 230 (such as display 150) is combined with a touch panel to form a touchscreen, which senses touch inputs on the display unit 230. The communication unit 240 (such as communication interface 160) detects occurrences of a network path change under control of the control unit 210, and, upon detection of a network path change, sends information on the new network to the control unit 210.

According to an embodiment of the present disclosure, the electronic device (such as mobile terminal or electronic device 101) includes a communication unit (such as communication interface 160 or communication unit 240) to monitor the network path and sense a change in the network path through monitoring. The electronic device also includes a control unit (such as control unit 210) to control, upon detection of a change in the network path, a process of converting DNS addresses into ones conforming to the new network and updating the DNS cache with the converted DNS addresses.

Upon detection of a change in the network path through the communication unit 240, the control unit 210 loads DNS addresses stored in the electronic device. The control unit 210 checks the amount of traffic on the new network, and converts DNS addresses into ones conforming to the new network in stages or in a lump according to the amount of traffic. The control unit 210 performs communication using the converted DNS addresses. The DNS cache stores DNS addresses frequently accessed through the network.

In response to a request for a DNS address during data transmission and reception, the control unit 210 checks whether the requested DNS address is present in the DNS cache, and, if the requested DNS address is present in the DNS cache, adjusts the priority of the requested DNS address and updates the DNS cache according to the adjusted priority. If the requested DNS address is not present in the DNS cache, the control unit 210 stores the requested DNS address in the DNS cache. The control unit 210 deletes a DNS address with a low priority from the DNS cache after storage of the requested DNS address. The control unit 210 assigns priority to DNS addresses on the basis of a recent access or use or a frequency of access or use. The network is at least one of an Ethernet network, cellular network, Wi-Fi network, Wi-Fi Direct network, Bluetooth network, and USB tethered network.

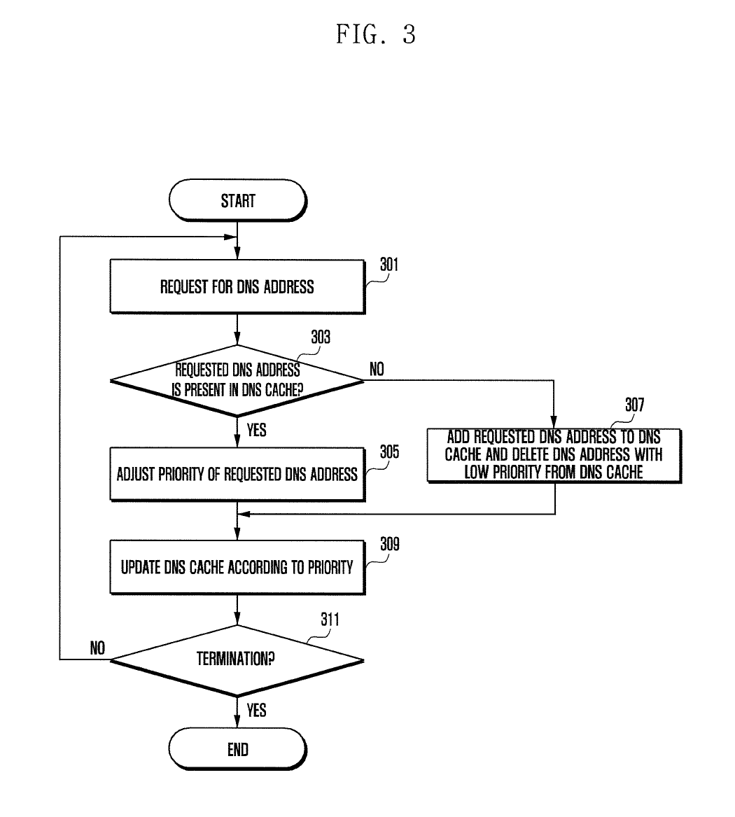

FIG. 3 is a flowchart of an example procedure for updating DNS cache according to this disclosure. Referring to FIG. 3, at operation 301, the control unit 210 of the electronic device detects a request for a DNS address through the communication unit 240. The request for a DNS address is issued during data transmission and reception to and from a network. The request for a DNS address is issued to access a site for application downloading. The control unit 210 obtains a DNS address from a network (such as wireless access point or base station) connected through the communication unit 240. The obtained DNS address is stored in the DNS cache. Later, when a request for a DNS address is issued, the DNS cache is searched first for the DNS address.

At operation 303, the control unit 210 checks whether the requested DNS address is present in the DNS cache. If the requested DNS address is present in the DNS cache, at operation 305, the control unit 210 adjusts the priority of the DNS address if necessary. Here, it is assumed that high priorities are assigned to recently used or accessed DNS addresses. However, embodiments of the present disclosure are not limited thereto, and high priorities are assigned to frequently used or accessed DNS addresses. For example, as the requested DNS address is a newly used one, the priority thereof is raised.

If the requested DNS address is not present in the DNS cache, at operation 307, the control unit 210 adds the requested DNS address to the DNS cache and deletes a DNS address with a low priority from the DNS cache. For example, assume that the DNS cache store up to N DNS addresses. Then, the control unit 210 deletes a DNS address with a low priority from the DNS cache if the number of DNS addresses is greater than N, and adds a requested DNS address to the DNS cache with priority adjustment without deletion of a DNS address if the number of DNS addresses is not greater than N.

At operation 309, the control unit 210 updates the DNS cache according to priority adjustment performed at operation 305 or 307. At operation 311, the control unit 210 checks whether a termination command is issued. Here, a termination command is issued when data transmission and reception through the network is discontinued. If a termination command is issued, the procedure is ended. If a termination command is not issued, the procedure returns to operation 301.

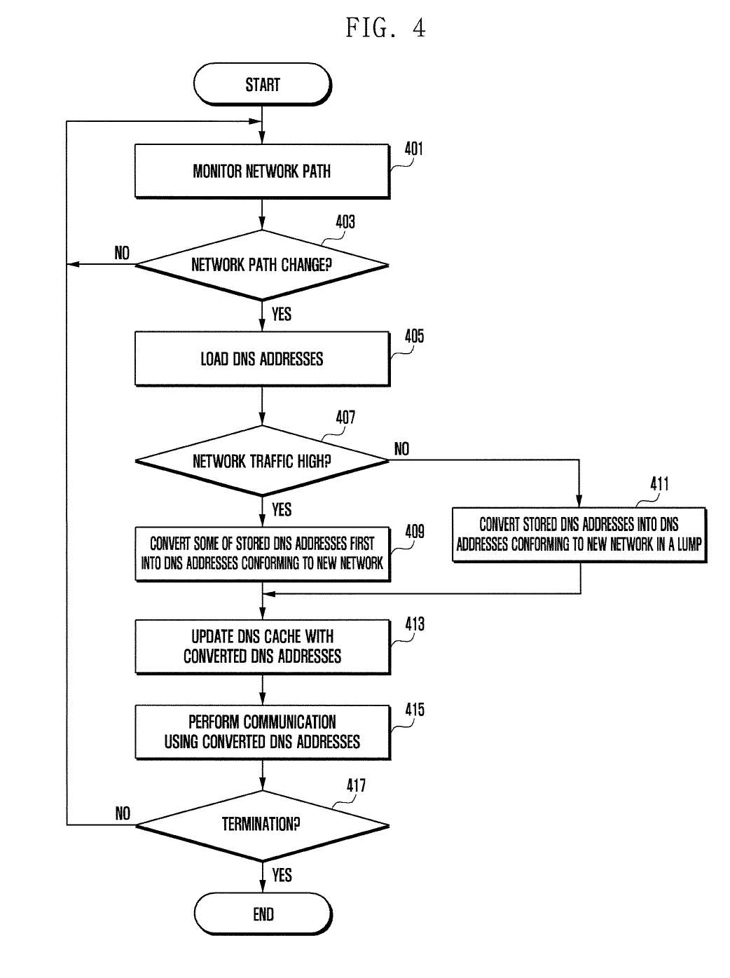

FIG. 4 is a flowchart of an example procedure to conform a DNS address with network path change according to this disclosure. Referring to FIG. 4, the control unit 210 performs data transmission and reception through the network. Here, the network is an Ethernet network, cellular network, Wi-Fi network, Wi-Fi Direct network, BLUETOOTH network, or USB tethered network. Data transmission and reception is related with streaming of video or music, application downloading, or Internet browsing. At operation 401, the control unit 210 monitors the network path during data transmission and reception via the network. Here, monitoring is conducted to detect occurrence of a network path change. When a network path change is detected, for data transmission and reception without disruption, the control unit 210 performs DNS address conversion so that DNS addresses conform to the new network.

At operation 403, the control unit 210 checks occurrence of a network path change. Here, a network path change corresponds to a change from a cellular network to a Wi-Fi network or a change from a Wi-Fi network to a cellular network. Occurrence of a network path change is detected by switching between network interfaces with which the electronic device is connected. When a network path change occurs during data transmission and reception, the control unit 210 converts existing DNS addresses into ones conforming to the new network and perform communication using the converted DNS addresses.

If a network path change has occurred, at operation 405, the control unit 210 loads DNS addresses stored in the DNS cache. At operation 407, the control unit 210 examines the amount of network traffic. Here, the amount of network traffic depends upon, for example, downloading of an application through the network and the number of simultaneously running tasks during music streaming. For network performance, the control unit 210 adjusts the speed or timing of DNS cache update when network traffic is high.

If the amount of network traffic is large, at operation 409, the control unit 210 converts some of DNS addresses stored in the DNS cache first into DNS addresses conforming to the new network. Here, a threshold is set in advance to indicate the number of DNS addresses to be converted at one time when network traffic is high. This stepwise DNS address conversion contributes to prevention of delay of network response speed. If the amount of network traffic is small, at operation 411, the control unit 210 converts DNS addresses stored in the DNS cache into DNS addresses conforming to the new network in a lump. At operation 413, the control unit 210 updates the DNS cache with the converted DNS addresses.

In the above description, the control unit 210 is depicted as adjusting the speed or timing of DNS cache update according to the amount of network traffic. However, embodiments of the present disclosure are not limited thereto. For example, the control unit 210 converts loaded DNS addresses into DNS addresses conforming to the new network without examining network traffic. When the network is changed from a Wi-Fi network to an LTE network, the DNS address of a website after the network change (DNS address conforming to the LTE network) is different from that before the network change (DNS address conforming to the Wi-Fi network). After the network change, as the website is not accessible using the old DNS address conforming to the Wi-Fi network, it is necessary to obtain the DNS address conforming to the LTE network. In the present invention, upon detection of a network change from a Wi-Fi network to an LTE network, existing DNS addresses conforming to the Wi-Fi network are automatically converted into DNS addresses conforming to the LTE network instead of newly obtaining DNS addresses conforming to the LTE network, and the DNS cache is updated accordingly. Hence, user tasks are more smoothly processed in the event of a network path change.

At operation 415, the control unit 210 performs communication using the converted DNS addresses. At operation 417, the control unit 210 checks whether a termination command is issued. Here, a termination command is issued when data transmission and reception through the network is discontinued. If a termination command is issued, the procedure is ended. If a termination command is not issued, the procedure returns to operation 401 and network monitoring is continued.

In an embodiment, the DNS address management method for an electronic device includes monitoring the network path. The method also includes converting, upon detection of a change in the network path, DNS addresses into ones conforming to the new network. The method further includes updating the DNS cache with the converted DNS addresses. Upon detection of a change in the network path, DNS addresses stored in the electronic device is loaded. Converting DNS addresses include checking the amount of traffic on the new network and converting DNS addresses into ones conforming to the new network in stages or in a lump according to the amount of traffic. The DNS cache stores DNS addresses frequently accessed through the network. Monitoring the network path further includes transmitting and receiving data. Transmitting and receiving data includes checking, in response to a request for a DNS address, whether the requested DNS address is present in the DNS cache, adjusting, if the requested DNS address is present in the DNS cache, the priority of the requested DNS address, and updating the DNS cache according to the adjusted priority.

If the requested DNS address is not present in the DNS cache, the requested DNS address is stored in the DNS cache and a DNS address with a low priority is deleted from the DNS cache. Priority is assigned to DNS addresses on the basis of recent access or use or a frequency of access or use. After DNS cache update, communication is performed using the converted DNS addresses. The network is at least one of an Ethernet network, cellular network, Wi-Fi network, Wi-Fi Direct network, Bluetooth network, and USB tethered network.

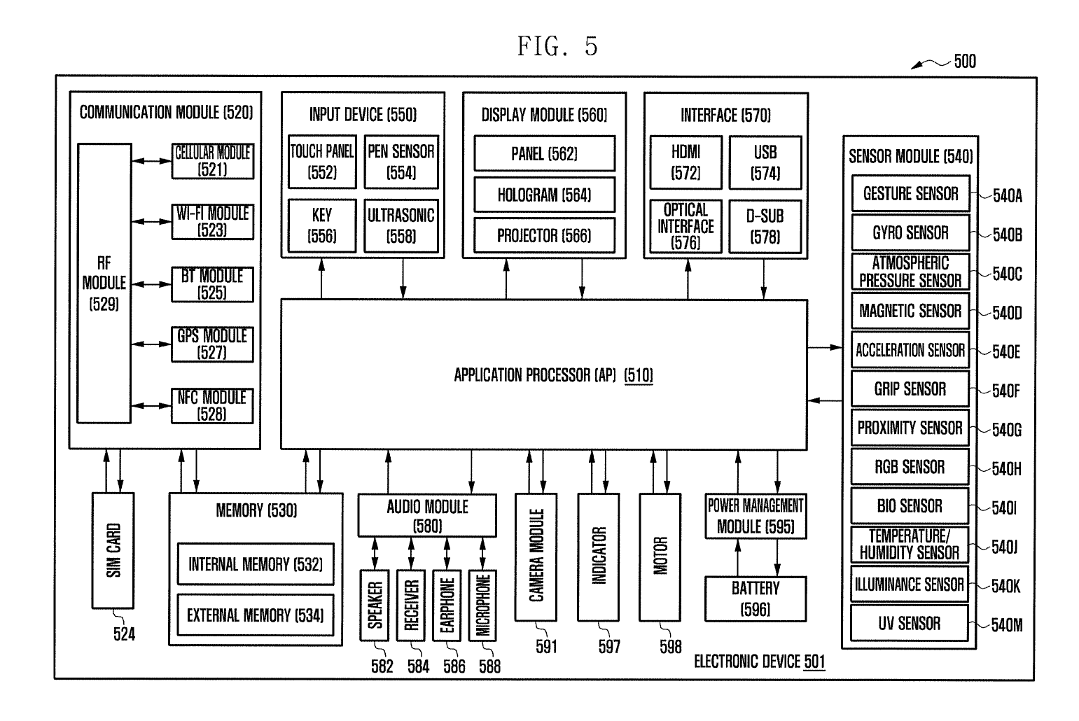

FIG. 5 is a block diagram of an example electronic device according to this disclosure. The electronic device 501 is of the whole or a part of the electronic device 101. Referring to FIG. 5, the electronic device 501 includes an Application Processor (AP) 510, a communication module 520, a Subscriber Identity Module (SIM) card 524, a memory 530, a sensor module 540, an input device 550, a display 560, an interface 570, an audio module 580, a camera module 591, a power management module 595, a battery 596, an indicator 597, and a motor 598.

The AP 510 operates an Operating System (OS) or application programs to control a plurality of hardware and/or software components connected to the AP 510 and perform data-processing and operations on multimedia data. For example, the AP 510 is implemented in the form of System on Chip (SoC). According to an embodiment, the AP 510 includes a Graphic Processing Unit (GPU) (not shown). The communication module 520 (such as communication interface 160) performs data communication with other electronic devices (such as electronic device 104 and server 106) through a network. According to an embodiment, the communication module 520 includes a cellular module 521, a Wi-Fi module 523, a BT module 525, a GPS module 527, an NFC module 528, and a Radio Frequency (RF) module 529.

The cellular module 521 is responsible for voice and video communication, text messaging, and Internet access services through a communication network (such as LTE, LTE-A, CDMA, WCDMA, UMTS, WiBro, and GSM networks). The cellular module 521 performs identification and authentication of electronic devices in the communication network using the SIM card 524. According to an embodiment, the cellular module 521 performs at least one of the functions of the AP 510. For example, the cellular module 521 performs at least a part of the multimedia control function.

According to an embodiment, the cellular module 521 includes a Communication Processor (CP). The cellular module 521 is implemented in the form of SOC. Although the cellular module 521 (such as a communication processor), the memory 530, and the power management module 595 are depicted as independent components separated from the AP 510, the present disclosure is not limited thereto but is embodied in a way that the AP includes at least one of the components (such as cellular module 521). According to an embodiment, each of the AP 510 and the cellular module 521 (such as a communication processor) loads a command or data received from at least one of the components on a non-volatile or volatile memory and process the command or data. The AP 510 or the cellular module 521 stores the data received from other components or generated by at least one of other components in the non-volatile memory.

Each of the Wi-Fi module 523, the BT module 525, the GPS module 527, and the NFC module 528 includes a processor for processing the data it transmits/receives. Although the cellular module 521, the Wi-Fi module 523, the BT module 525, the GPS module 527, and the NFC module 528 are depicted as independent blocks; at least two of them (such as a communication processor corresponding to the cellular module 521 and Wi-Fi processor corresponding to the Wi-Fi module 523) is integrated in the form of SoC.

The RF module 529 is responsible for data communication, such as transmitting or receiving RF signals. The RF module 529 includes a transceiver, a Power Amp Module (PAM), a frequency filter, and a Low Noise Amplifier (LNA). The RF module 529 also includes the elements for transmitting or receiving electric wave in free space, such as a conductor or conductive wire. Although FIG. 5 is directed to the case where the Wi-Fi module 523, the BT module 525, the GPS module 527, and the NFC module 528 are sharing the RF module 529, the present disclosure is not limited thereto but is embodied in a way that at least one of the Wi-Fi module 523, the BT module 525, the GPS module 527, and the NFC module 528 transmits/receives RF signals an independent RF module 529.

The SIM card 524 is designed so as to be inserted into a slot formed at a predetermined position of the electronic device. The SIM card 524 stores unique identity information (such as an Integrated Circuit Card Identifier (ICCID)) or subscriber information (such as an International Mobile Subscriber Identity (IMSI)). The memory 530 (such as memory 130) includes at least one of the internal memory 532 and an external memory 534. The internal memory 532 includes at least one of a volatile memory (such as Dynamic Random Access Memory (DRAM), Static RAM (SRAM), Synchronous Dynamic RAM (SDRAM) or a non-volatile memory (such as One Time Programmable Read Only Memory (OTPROM), Programmable ROM (PROM), Erasable and Programmable ROM (EPROM), Electrically Erasable and Programmable ROM (EEPROM), mask ROM, flash ROM, NAND flash memory, and NOR flash memory).

According to an embodiment, the internal memory 532 is a Solid State Drive (SSD). The external memory 534 is a flash drive such as Compact Flash (CF), Secure Digital (SD), micro-SD, Mini-SD, extreme Digital (xD), and Memory Stick. The external memory 534 is connected to the electronic device 501 through various interfaces functionally. According to an embodiment, the electronic device 501 includes a storage device (or storage medium) such as hard drive. The sensor module 540 measures physical quantity or check the operation status of the electronic device 501 and convert the measured or checked information to an electric signal. The sensor module 540 includes at least one of gesture sensor 540A, Gyro sensor 540B, atmospheric pressure sensor 540C, magnetic sensor 540D, acceleration sensor 540E, grip sensor 540F, proximity sensor 540G, color sensor 540H (such as a Red, Green, Blue (RGB) sensor), bio sensor 540I, temperature/humidity sensor 540J, illuminance sensor 540K, and Ultra Violet (UV) sensor 540M. Additionally or alternatively, the sensor module 540 includes E-nose sensor, Electromyography (EMG) sensor, Electroencephalogram (EEG) sensor, Electrocardiogram (ECG) sensor, Infrared (IR) sensor, iris sensor, and fingerprint sensor. The sensor module 540 further includes a control circuit for controlling at least one of the sensors included therein.

The input device 550 includes a touch panel 552, a (digital) pen sensor 554, keys 556, and an ultrasonic input device 558. The touch panel 552 is one of capacitive, resistive, infrared, microwave type touch panel. The touch panel 552 includes a control circuit. In the case of the capacitive type touch panel, it is possible to detect physical contact or approximation. The touch panel 552 further includes a tactile layer. In this case, the touch panel 552 provides the user with haptic reaction.

The (digital) pen sensor 554 is implemented with a sheet with the same or similar way as touch input of the user or a separate recognition sheet. The keys 556 include physical buttons, optical key, and keypad. The ultrasonic input device 558 is a device capable of checking data by detecting sound wave through a microphone 588 and is implemented for wireless recognition. According to an embodiment, the electronic device 501 receives the user input made by means of an external device (such as a computer or a server) connected through the communication module 520.

The display 560 (such as display module 150) includes a panel 562, a hologram device 564, and a projector 566. The panel 562 is a Liquid Crystal Display (LCD) panel or an Active Matrix Organic Light Emitting Diodes (AMOLED) panel. The panel 562 is implemented so as to be flexible, transparent, and/or wearable. The panel 562 is implemented as a module integrated with the touch panel 552. The hologram device 564 presents 3-dimensional image in the air using interference of light. The projector 566 projects an image to a screen. The screen is placed inside or outside the electronic device. According to an embodiment, the display 560 includes a control circuit for controlling the panel 562, the hologram device 564, and the projector 566.

The interface 570 includes a High-Definition Multimedia Interface (HDMI) 572, a Universal Serial Bus (USB) 574, an optical interface 576, and a D0subminiature (D-sub) 578. The interface 570 includes the communication interface 160 as shown in FIG. 1. Additionally or alternatively, the interface 570 includes a Mobile High-definition Link (MHL) interface, a SD/MMC card interface, and infrared Data Association (irDA) standard interface.

The audio module 580 converts sound to electric signal and vice versa. At least a part of the audio module 580 is included in the input/output interface 140 as shown in FIG. 1. The audio module 580 processes the audio information input or output through the speaker 582, the receiver 584, the earphone 586, and the microphone 588. The camera module 591 is a device capable of taking still and motion pictures and, according to an embodiment, includes at least one image sensor (such as front and rear sensors), a lens, and Image Signal Processor (ISP), and a flash (such as LED or xenon lamp). The power management module 595 manages the power of the electronic device 501. The power management module 595 includes a Power Management Integrated Circuit (PMIC), a charger Integrated Circuit (IC), a battery, and a battery or fuel gauge.

The PMIC is integrated into an integrated circuit or SoC semiconductor. The charging is classified into wireless charging and wired charge. The charger IC charges the battery and protects the charger against overvoltage or overcurrent. According to an embodiment, the charger IC includes at least one of wired charger and wireless charger ICs. Examples of the wireless charging technology includes resonance wireless charging and electromagnetic wave wireless charging, and there is a need of extra circuit for wireless charging such as coil loop, resonance circuit, and diode. The battery gauge measures the residual power of the battery 596, charging voltage, current, and temperature. The battery 596 stores or generates power and supplies the stored or generated power to the electronic device 501. The battery 596 includes a rechargeable battery or a solar battery.

The indicator 597 displays operation status of the electronic device 501 or a part of the electronic device, booting status, messaging status, and charging status. The motor 598 converts the electronic signal to mechanical vibration. The electronic device 501 includes a processing unit (such as GPU) for supporting mobile TV. The processing unit for supporting the mobile TV is able to processing the media data abiding by the broadcast standards such Digital Multimedia Broadcasting (DMB), Digital Video Broadcasting (DVB), and media flow. Each of the components of the electronic device according to the present disclosure is implemented by one or more components and the name of the corresponding component varies depending on a type of the electronic device. An embodiment of the present disclosure includes at least one of the above-described elements. Some of the above-described elements may be omitted or further includes additional elements. Further, some of the components of the electronic device according to the present disclosure are combined to be one entity, which performs the same functions as those of the components before the combination.

The term “module” used in the present disclosure refers to, for example, a unit including one or more combinations of hardware, software, and firmware. The “module” is interchangeably used with a term, such as unit, logic, logical block, component, or circuit. The “module” is the smallest unit of an integrated component or a part thereof. The “module” is the smallest unit that performs one or more functions or a part thereof. The “module” is mechanically or electronically implemented. For example, the “module” according to the present disclosure includes at least one of an Application-Specific Integrated Circuit (ASIC) chip, a Field-Programmable Gate Arrays (FPGA), and a programmable-logic device for performing operations which has been known or are to be developed hereinafter.

According to various embodiments, at least some of the devices (for example, modules or functions thereof) or the method (for example, operations) according to the present disclosure is implemented by a command stored in a computer-readable storage medium in a programming module form. When he command is executed by one or more processors (for example, the control unit 210), the one or more processors executes a function corresponding to the command. The computer-readable storage medium is, for example, the storage unit 220. At least a part of the programming module is implemented (for example, executed) by, for example, the control unit 210. At least some of the programming modules include, for example, a module, a program, a routine, a set of instructions or a process for performing one or more functions.

The computer-readable recording medium includes magnetic media such as a hard disk, a floppy disk, and a magnetic tape, optical media such as a Compact Disc Read Only Memory (CD-ROM) and a Digital Versatile Disc (DVD), magneto-optical media such as a floptical disk, and hardware devices specially configured to store and perform a program instruction (for example, programming module), such as a Read Only Memory (ROM), a Random Access Memory (RAM), a flash memory and the like. In addition, the program instructions include high class language codes, which are executed in a computer by using an interpreter, as well as machine codes made by a compiler. The aforementioned hardware device is configured to operate as one or more software modules in order to perform the operation of the present disclosure, and vice versa.

The programming module according to the present disclosure includes one or more of the aforementioned components or further includes other additional components, or some of the aforementioned components may be omitted. Operations executed by a module, a programming module, or other component elements according to various embodiments of the present disclosure can be executed sequentially, in parallel, repeatedly, or in a heuristic manner. Further, some operations can executed according to another order or can be omitted, or other operations can be added.

According to an embodiment of the present invention, a computer readable storage medium stores a program implementing the DNS address management method for an electronic device, wherein the program is configured to monitor the network path, convert, upon detection of a change in the network path, DNS addresses into ones conforming to the new network, and update the DNS cache with the converted DNS addresses.

In a feature of the present invention, when the network path is changed, the electronic device automatically updates the existing DNS cache with addresses corresponding to the changed network. Hence, network performance can be increased.

In addition, as the electronic device updates the DNS cache according to network states, the load due to cache update is dynamically adjusted. Hence, the user uses the network in a more convenient manner.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method to manage Domain Name System (DNS) addresses in an electronic device, the method comprising:
upon detecting a change in a network path to a new network, converting DNS addresses stored in a DNS cache to conform to the new network; and
updating the DNS cache with the converted DNS addresses.

2. The method of claim 1, further comprising upon detecting the change in the network path to the new network, loading DNS addresses stored in the electronic device.

3. The method of claim 1, wherein converting DNS addresses comprises:
checking an amount of traffic on the new network; and
converting the DNS addresses to conform to the new network in stages or at once according to the amount of traffic.

4. The method of claim 1, wherein the DNS cache stores DNS addresses frequently accessed or used through a network.

5. The method of claim 1, further comprising monitoring the network path to detect the change in the network path to the new network by transmitting and receiving data, and wherein transmitting and receiving data comprises:
checking, in response to a request for a DNS address, whether the requested DNS address is present in the DNS cache;
adjusting, when the requested DNS address is present in the DNS cache, the priority of the requested DNS address; and
updating the DNS cache according to the adjusted priority.

6. The method of claim 5, wherein transmitting and receiving data further comprises adding, when the requested DNS address is not present in the DNS cache, the requested DNS address to the DNS cache, and deleting a DNS address with a low priority from the DNS cache.

7. The method of claim 5, wherein priority is assigned to DNS addresses according to a recent access or use or a frequency of access or use.

8. The method of claim 1, further comprising performing communication using the converted DNS addresses.

9. The method of claim 1, wherein the network comprises at least one of an Ethernet network, cellular network, a Wi-Fi network, a Wi-Fi Direct network, a Bluetooth network, and a USB tethered network.

10. An electronic device capable of Domain Name System (DNS) address management, comprising:
processing circuitry configured to:
convert, upon detecting a change in a network path to a new network, DNS addresses stored in a DNS cache to conform to the new network; and
update the DNS cache with the converted DNS addresses.

11. The electronic device of claim 10, wherein, upon detecting the change in the network path through a communication circuitry, the processing circuitry is configured to load DNS addresses stored in the DNS cache.

12. The electronic device of claim 10, wherein the processing circuitry is configured to check an amount of traffic on the new network and convert the DNS addresses to conform to the new network in stages or at once according to the amount of traffic.

13. The electronic device of claim 10, wherein the processing circuitry is configured to perform communication using the converted DNS addresses.

14. The electronic device of claim 10, wherein the DNS cache is configured to store DNS addresses frequently accessed or used through a network.

15. The electronic device of claim 10, wherein, in response to a request for a DNS address during data transmission and reception, the processing circuitry is configured to check whether the requested DNS address is present in the DNS cache, adjust, when the requested DNS address is present in the DNS cache, the priority of the requested DNS address, and update the DNS cache according to the adjusted priority.

16. The electronic device of claim 15, wherein, when the requested DNS address is not present in the DNS cache, the processing circuitry is configured to add the requested DNS address to the DNS cache.

17. The electronic device of claim 16, wherein the processing circuitry is configured to delete a DNS address with a low priority from the DNS cache after adding the requested DNS address.

18. The electronic device of claim 15, wherein the processing circuitry is configured to assign a priority to DNS addresses on the basis of a recent access or use or a frequency of access or use.

19. The electronic device of claim 10, wherein the network comprises at least one of an Ethernet network, a cellular network, a Wi-Fi network, a Wi-Fi Direct network, a BLUETOOTH network, and a USB tethered network.

20. A non-transitory, computer readable storage medium storing a program to perform Domain Name System (DNS) address management in an electronic device, that, when executed by a processor of the electronic device, cause the processor of the electronic device to:
convert, upon detecting a change in a network path to a new network, DNS addresses stored in a DNS cache to conform to the new network; and
update the DNS cache with the converted DNS addresses.
